(19) United States
(12) Patent Application Publication
(10) Pub. No.: US 2010/0250388 A1
(43) Pub. Date: Sep. 30, 2010

(54) METHOD AND APPARATUS FOR PROTECTING DRM CONTENTS

(75) Inventor: Sang Cheol Lee, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/714,622

(22) Filed: Mar. 1, 2010

(30) Foreign Application Priority Data
Mar. 31, 2009 (KR) 10-2009-0027311

(51) Int. Cl. G06Q 30/00; G06F 7/04; G06Q 99/00; G06Q 50/00

(52) U.S. Cl. 705/26; 726/26; 705/310

(57) ABSTRACT

A method and apparatus for limiting access to content protected by digital rights management (DRM) technology is disclosed. In accordance with the method, when a key pair for a license to reproduce DRM content is created, a determination is made as to whether an identification card is registered at a mobile communication server. If the identification card is registered at the mobile communication server, a first key pair is created using an unique identification stored on the identification card as a seed value. If the identification card is not registered at the mobile communication server, a second key pair is created using a random value as a seed value.

### CLAIM OF PRIORITY

This application claims, pursuant 35 U.S.C. §119(a), priority to, and the benefit of the earlier filing date of, that patent application filed in the Korean Intellectual Property Office on Mar. 31, 2009, entitled “Method and Apparatus for Protecting DRM Contents,” and assigned Serial No. 10-2009-0027311, the entire disclosure of which is hereby incorporated by reference.

### BACKGROUND OF THE INVENTION

1. Field of the Invention

The present invention relates to digital rights management (DRM), and more particularly, to a method and apparatus that prevents unauthorized use of DRM content stored in a portable terminal.

2. Description of the Related Art

As the interest regarding copyright protection of digital media or content has increased, a digital rights management (DRM) technology has been proposed to prevent illegal copying or re-distribution of paid content used in a portable terminal. DRM refers to a technology that applies an encryption technology to digital content in different formats to protect the rights of copyright holders. For example, the content may be in formats, such as text files, MP3 files, ring tones, moving images, games, etc. DRM provides a series of protection and management systems as digital content are created, published, distributed and used.

Content to which a DRM technology is applied, hereinafter called DRM content, always exist in an encrypted state, and allow only an authorized user to decode and use corresponding content. Although DRM content are duplicated, they do not allow for the access of a user who is not authenticated by a license, thereby preventing illegal copying.

A DRM license is created in a rights issuing server, hereinafter called a DRM server, and sold to digital content users. The DRM license is separated from DRM content and is stored in a portable terminal, so that it can restrict the execution of corresponding DRM content. In general, the types of DRM licenses may be divided in categories such as a count manner, an interval manner, a timed-count manner, an accumulation manner, etc.

A DRM license contains information that restricts the use of DRM content. For example, if a user purchases a particular MP3 file, and simultaneously a DRM license allowing the file to be played back for a known number of times (e.g., 10), the file can be reproduced only this known number times. In this type of DRM license, the count is reduced each time the MP3 file is played back. When the count is ‘zero’, the MP3 file cannot be played back until an additional DRM license is purchased.

Since the conventional method for protecting DRM content stores a license in a portable terminal, any users can use the DRM contents stored in the portable terminal. That is, when a portable terminal is lost, another user who picks up the portable terminal may use DRM content stored in the portable terminal. In particular, since the conventional DRM contents protection method charges users according to the frequency and time of using DRM content the original purchaser of the license must pay the bill charged according to the use of the DRM content, even though user (purchaser) lost a portable terminal and does not have access to the content.

### SUMMARY OF THE INVENTION

The present invention provides a method and apparatus that does not allow a user who picks up a portable terminal to use DRM content stored in the portable terminal, thereby protecting the DRM contents.

In accordance with an exemplary embodiment of the present invention, the present invention provides a method for protecting digital rights management (DRM) content of a portable terminal, including: checking whether an identification card is registered at a mobile communication server, the identification having a unique identification value; creating a first key pair using the unique identification value, if the identification card is registered at the mobile communication server; creating a second key pair using a random value, if the identification card is not registered at the mobile communication server; and storing at least one of the first and second key pair.

In accordance with another exemplary embodiment of the present invention, the present invention provides an apparatus for protecting digital rights management (DRM) content including: an agent for checking whether an identification card is registered at a mobile communication server, the identification having a unique identification value; and a DRM core for creating a first key pair, using the unique identification stored on the identification card, and a second key pair using a random value, and storing at least one of the first and second key pair, wherein the agent transfers the unique identification to the DRM core if the identification card is registered at the mobile communication server and transfers the random value to the DRM core if the identification card is not registered at the mobile communication server.

In accordance with another exemplary embodiment of the present invention, the present invention provides a portable terminal comprising: a processor in communication with a memory, the memory including code which when accessed by processor causes the processor to: determine whether an identification module associated with the portable terminal is registered at a remote site; determine a key pair as one of: a unique identification obtained from the identification module when the identification module is determined to be registered and a random value when the identification module is determined not to be registered, and access the DRM content when the selected key pair is valid and a license associated with the DRM content is available.

### BRIEF DESCRIPTION OF THE DRAWINGS

The above and other aspects, features and advantages of certain exemplary embodiments of the present invention will become more apparent from the following description taken in conjunction with the accompanying drawing, in which:

FIG. 1 is a schematic block diagram illustrating a DRM system according to an embodiment of the present invention;

FIG. 2 is a schematic block diagram illustrating a portable terminal according to an embodiment of the present invention;

FIG. 3 is a flow chart that describes a method for generating a key pair, according to an embodiment of the present invention; and

FIG. 4 is a flow chart that describes a method for reproducing DRM content, according to an embodiment of the present invention.

### DETAILED DESCRIPTION OF THE INVENTION

Exemplary embodiments of the present invention are described in detail with reference to the accompanying drawings. The same reference numbers are used throughout the drawings to refer to the same or similar parts. For the purposes of clarity and simplicity, detailed descriptions of well-known functions and structures incorporated herein may be omitted to avoid obscuring the subject matter of the present invention.

Prior to explaining the embodiments of the present invention, terminologies will be defined for the present description below. The terms or words described in the present description and the claims should not be limited by a general or lexical meaning, instead should be analyzed as a meaning and a concept through which the inventor defines and describes the present invention at his most effort, to comply with the idea of the present invention. Therefore, one skilled in the art will understand that the embodiments disclosed in the description and configurations illustrated in the drawings are only preferred embodiments, instead there may be various modifications, alterations, and equivalents thereof to replace the embodiments at the time of filing this application.

In general, in a global system for mobile communication (GSM) network, serving as a 2^{nd} generation communication network employing an asynchronous method, a universal mobile telecommunication system (UMTS) serving as a 3^{rd} generation communication network, advanced from the GSM network, and a general packet radio services (GPRS) network associated with an Internet network to provide a packet service, the networks includes an subscriber identity module (SIM) card for identifying subscribers, a universal SIM (USIM) card, etc. A wideband CDMA (WCDMA) network uses a user information module (UIM) card for identifying subscribers. In embodiments of the present invention, the term ‘SIM card’ will be used as a concept that includes the SIM, USIM, and UIM cards.

When a portable terminal equipped with the SIM card receives services from the networks described above, an authentication is made as to whether it is a proper subscriber based on subscriber identity information stored in the SIM card. If the portable terminal is authenticated as a proper subscriber, the terminal receives services from the networks. To this end, the SLIM card contains an international mobile subscriber identity (IMSI), etc., where the IMSI is unique.

IMSI refers to a unique value assigned to each SIM card and is generally composed of up to 15 digits. An IMSI of 15 digits contains a mobile country code (MCC) of 3 digits, a mobile network code (MNC) of 2-3 digits, and a mobile subscriber identifier number (MSIN) of maximum 10 digits. The MCC and MNC serve to identify a home network, for example, a home public land mobile network (HPLMN). That is, HPLMNs, each managed by service providers, have a unique MCC and MNC, respectively. The MSIN refers to a number that serves to identify portable terminal subscribers.

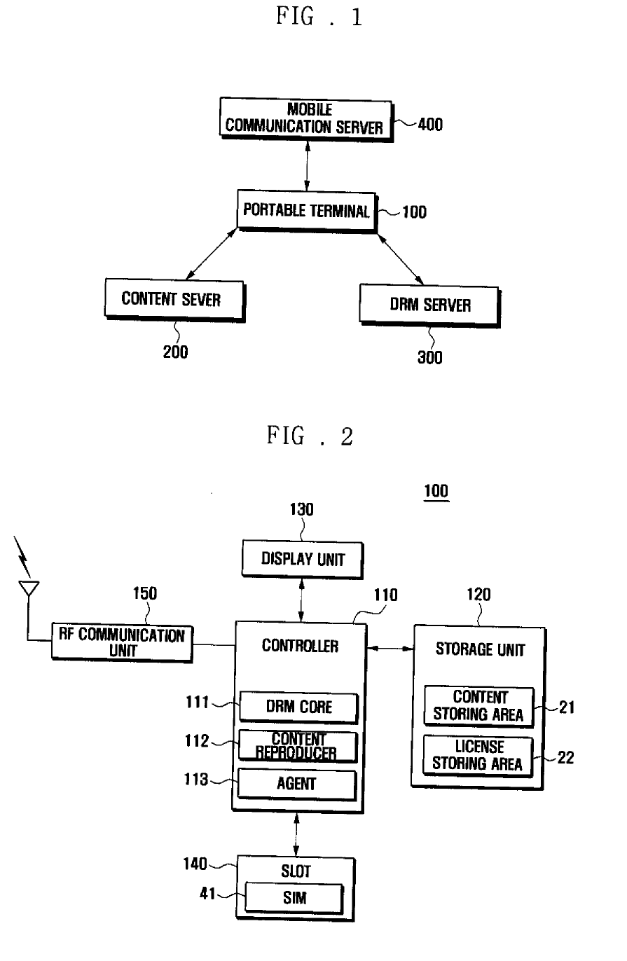

FIG. 1 is a schematic block diagram illustrating a DRM system according to an embodiment of the present invention.

Referring to FIG. 1, the portable terminal 100 accesses a content server 200 to purchase a particular content from the content server 200. In an embodiment of the present invention, the content server 200 may be a website server associated with, for example, a content, or a content manufacturer or a third party content provider. For example, the website site may be associated with a particular content, such as a movie that may be for sale or rent, or may be associated with a content manufacturer that produces and sells a plurality of content.

The content server 200 transmits the content, requested by the portable terminal 100, to the portable terminal 100. In an embodiment of the present invention, the content may be DRM content to which a DRM technology is applied. Applying a DRM technology to content implies that the content is encrypted using a predetermined encryption key and encryption format and contains use restriction information regarding the content, according to the predefined format. The use restriction information may include usage rules, frequency of played back usage and/or a period of allowed played back, etc.)

When the portable terminal 100 has received the requested content from the content server 200, the terminal transmits a message requesting a license regarding the received content to a DRM server 300. In an embodiment of the present invention, the DRM server 300 serves to manage licenses regarding DRM content. A license is a grant of permission to use the associated content. A license may contain use restriction information and an encryption key to decrypt DRM content.

The DRM server 300 determines whether the user of the portable terminal 100 is a proper user regarding the content. If the user of the portable terminal 100 is a proper user regarding the content, the DRM server 300 creates a license regarding the requested DRM content and then transmits it to the portable terminal 100.

The portable terminal 100 receives and stores the license from the DRM server 300. After that, if the portable terminal 100 is requested to play back DRM content, it plays back the DRM content, using the stored license.

The portable terminal 100 may store a key pair as the license. The key pair is composed of two key values in a pair (for example, a public key and a private key). When the portable terminal 100 is requested to play back DRM content, the terminal 100 acquires a license corresponding to a key pair and decrypts the DRM content requested to be played back. However, when the portable terminal 100 is lost, anyone accessing the portable terminal 100 may have access to the DRM content.

Therefore, the present invention aims to change the key pair when the portable terminal 100 is lost, thereby preventing the DRM content stored in the portable terminal 100 from being used.

To this end, the portable terminal 100 according to the present invention can create different key pairs according to whether its SIM card is registered. If a SIM card of the portable terminal 100 is registered at a mobile communication server 400, the portable terminal 100 may create an IMSI of the SIM card serving as a seed value, which is used as a first key pair. Also, if a SIM card of the portable terminal 100 is not, or no longer, registered at the mobile communication server 400 due to a loss report of the SIM card, the portable terminal 100 may create a random value serving as a seed value, which is used as a second key pair. In an embodiment of the present invention, when a SIM card of the portable terminal 100 is not registered at the mobile communication server 400 due to a loss report of the SIM card being filed, the portable terminal 100 may switch the first key pair to the second key pair and, thus, does not allow any other user who picks up the lost SIM card to use the DRM content stored in the portable terminal 100, thereby preventing the disclosure of the information or content within the portable terminal 100.

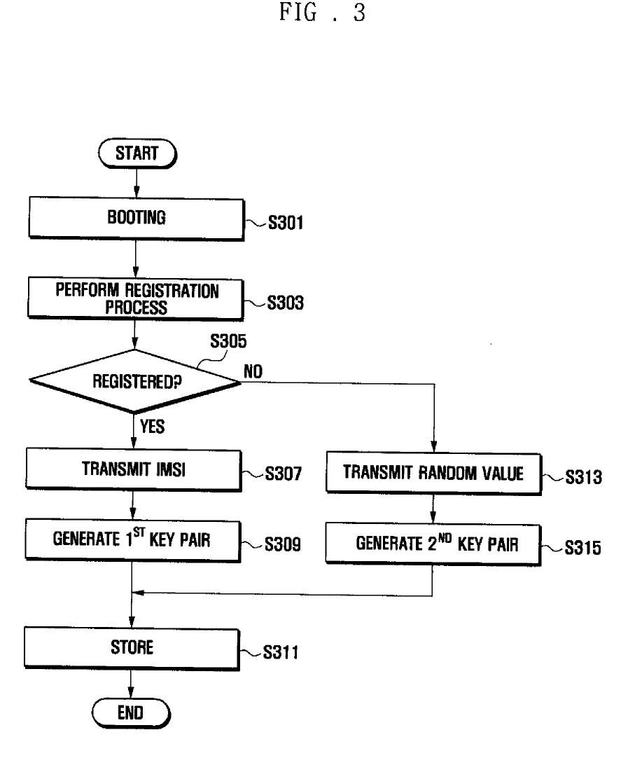

In the following description, the configuration of the portable terminal 100 is explained in detail with reference to FIG. 2.

FIG. 2 is a schematic block diagram illustrating a portable terminal according to an embodiment of the present invention.

In an embodiment of the present invention, although the portable terminal is explained based on a mobile communication terminal equipped with an SIM card, it should be understood that the present invention is not limited to the illustrated embodiment. That is, it will be appreciated that the portable terminal can be applied to all information communication devices, multimedia devices, and their applications, such as, a personal digital assistant (PDA), a smart phone, etc., if the devices include a function corresponding to that of the SIM card (or a module containing unique identification information). In addition, although the portable terminal according to the present invention is implemented to include the SIM card as shown in FIG. 2, it should be understood that the present invention is not limited to the illustrated embodiment. That is, the portable terminal may also be implemented to include other types of cards containing unique identification information to process portable terminal authentication or subscriber authentication. For example, the portable terminal may include a USIM card, a UIM card, or the like instead of the SIM card referred to.

Referring to FIGS. 1 and 2, the portable terminal 100 includes an RF communication unit 150, a slot 140, a display unit 130, a storage unit 120, and a controller 110.

The slot 140 refers to a device to receive a SIM card 41. The slot 140 serves as an interface between the SIM card 41 and the controller 110. The SIM card 41 is configured as a module shaped as a card type that can be installed into or removed from the portable terminal 100. The SIM card 41 may also include an embedded microprocessor and a memory chip. The memory chip may store various subscriber information, such as a user's phone number, a password, billing information, etc., and an international mobile subscriber identity (IMSI) for identifying subscribers.

The RF communication unit 150 performs a communication function of the portable terminal 100. The RF communication unit 150 establishes a communication channel with a mobile communication network (not shown) and performs a voice call, a video telephony call, a data call, or the like. To this end the RF communication unit 150 is configured to include an RF transmitter for up-converting the frequency of transmitted signals and amplifying the transmitted signals and an RF receiver for low-noise amplifying received RF signals and down-converting the frequency of the received RF signals. When the portable terminal 100 is booted up, the RF communication unit 150 may transmit a registration requesting message to the mobile communication server 400. If a loss notice of the SIM card is recorded, the RF communication unit 150 may receive a message indicating that the registration process cannot be performed from the mobile communication server 400. The RF communication unit 150 may also download at least one DRM content or general content from the content server 300 under the control of the controller 110. In addition, the RF communication unit 150 transmits a message requesting to purchase a license, required to reproduce the downloaded DRM content, to the DRM server 300, and then downloads the license therefrom.

The display unit 130 displays screen data generated when the portable terminal 100 is operated and state information according to a user's key operation and function settings. The display unit 130 may also display a variety of signals and color information output from the controller 110. The display unit 130 may be implemented with a liquid crystal display (LCD), an organic light emitting diode (OLED), etc. If the display unit 130 is implemented with a touch screen, it may also serve as an input device. In an embodiment of the present invention, the display unit 130 displays a screen when the DRM content is reproduced. If a license required to reproduce DRM content is not stored in the portable terminal 100, the display unit 130 may display a screen asking the user whether the user wishes to purchase a license. The display unit 130 may for example, provide a pop-up message checking whether to purchase a license.

The storage unit 120 stores programs that may control the operation of the portable terminal 100 (operating system), application programs required to communicate with a wireless communication network, and data generated when the application programs are executed. That is, the storage unit 120 stores an operating system (OS) for booting up the portable terminal 100, and application programs required to operate the function(s) of the portable terminal 100, and data generated when the portable terminal 100 is operated. The storage unit 120 is composed of read only memory (ROM), and/or random access memory (RAM), etc. In an embodiment of the present invention, the storage unit 120 includes a content storage area 21 and a license storage area 22. The content storage area 21 stores general content or DRM content received from the content server 200 or which was pre-stored. The license storage area 22 stores licenses from the DRM server 300. The storage unit 120 may also store an application program for controlling the general operation of the portable terminal 100 and one or more application programs for reproducing digital content. To this end, the storage unit 120 may further include an application storage area (not shown).

The controller 110 controls the operation of the portable terminal 100 and the flow of signals among the elements in the portable terminal 100. Examples of the elements are the RF communication unit 150, the display unit 130, the storage unit 120, the slot 140, etc. In an embodiment of the present invention, the controller 110 includes a DRM core 111, a content reproducer 112, an agent 113, etc.

The DRM core 111 acquires a license from the DRM server 300 and decodes DRM content using the acquired license. The DRM core 111 creates a key pair. The key pair is composed of a first key pair, generated by the IMSI of the SIM card 41, and a second key pair generated by a random value. To this end, if the SIM card 41 is registered at a mobile communication server 400 during the booting process, the agent 113 transfers the IMSI of the SIM card 41 to the DRM core 111. However, if the SIM card 41 is not registered at the mobile communication server 400, the agent 113 transfers a random value to the DRM core 111. The SIM card may not be registered at the communication server 400 because of the generation of a loss report indicating that the SIM card has been lost or otherwise not available to the original user.

In an embodiment of the present invention, if DRM content is requested to be played back, the DRM core 111 determines whether a license corresponding to the DRM content is stored. To this end, the DRM core 111 may use the key pair. For example, if the DRM core 111 has the first key pair, it can decode DRM content using the license corresponding to the first key pair. However, if the DRM core 111 has the second key pair, it cannot find a license corresponding to the second key pair and thus cannot decode the DRM content. Thus, another user who picks up a portable terminal 100 and attempts to purchase a license using the second key pair, the DRM server 300 ascertains that the user is not a proper user and thus rejects the license purchase request, thereby protecting the rights of the original user of the portable terminal 100. On the other hand, if the other user who picks up a portable terminal 100 installs their own SIM card to the portable terminal 100, the SIM card can be registered at the mobile communication server 400. In that case, however, the IMSI value of the SIM card differs from that of the original SIM card of the portable terminal 100, and thus the key pair also differs from the original key pair. Therefore, the user who picks up the portable terminal 100 cannot decode DRM contents stored in the portable terminal 100. If the other user, however, requests to purchase a license, they will be charged with the fee since their IMSI is used. Therefore, this can protect the rights of the original user who lost the portable terminal 100.

In an embodiment of the present invention described above, although the DRM core 111 uses the IMSI to create the key pair, it should be understood that the present invention is not limited to the embodiment. For example, when creating the key pair, the DRM core 111 may use other values according to a unique algorithm in order to prevent an illegal use, such as a hacking, instead of employing the IMSI. These other values may represent unique identifications of the mobile terminal.

The content reproducer 112 serves to reproduce general content and DRM content. When the content reproducer 112 detects a request to reproduce content, it asks the DRM core 111 whether the content corresponds to DRM content or general content. If the requested content is DRM content, the content reproducer 112 reproduces corresponding DRM content using a license related to the corresponding DRM content.

The agent 113 transfers a seed value required to create a key pair to the DRM core 111. The agent 113 determines whether the SIM card 41 is registered. If the agent 113 ascertains that the SIM card 41 has been registered at the mobile communication server 400, it transfers the IMSI of the SIM card 41, as a seed value, to the DRM core 111. However, if the agent 113 ascertains that the SIM card 41 is not registered at the mobile communication server 400, the agent 113 transfers a random value, as a seed value, to the DRM core 111. For example, when the portable terminal 100 is lost, the system and method according to the present invention does not allow the SIM card 41 of the portable terminal 100 to be registered or de-registers, at the mobile communication server 400, so that another user who picks up the portable terminal 100 cannot use DRM contents stored in the portable terminal 100.

Although it is not shown in the drawings, the portable terminal 100 may further include a camera module for capturing images or moving images, a short-range communication module for performing short-range communication, a broadcast receiver module for receiving broadcasts, a digital audio source reproducing module such as an MP3 player module, an Internet communication module for performing communication with the Internet, etc. With the convergence of digital devices, there may be many digital devices and modifications thereof, in the terminal that are not listed herein, and, it will be appreciated that they can also be included in the portable terminal.

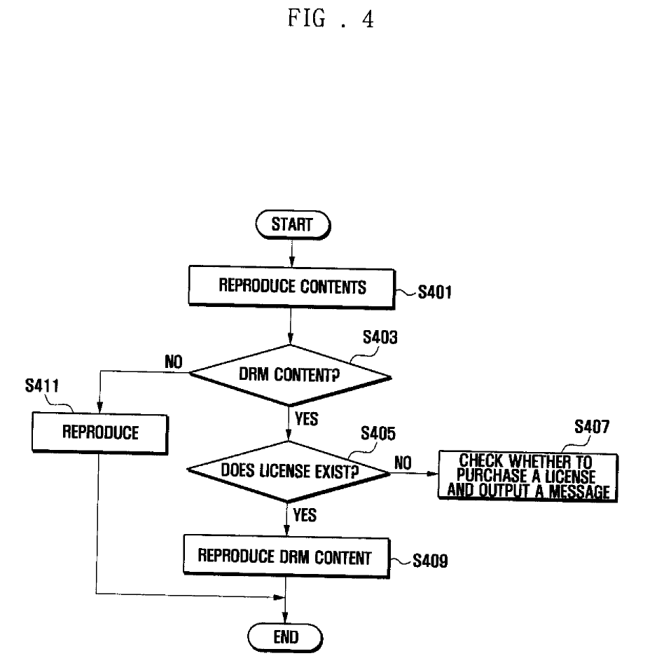

In the foregoing description, the apparatus for protecting DRM contents, according to an embodiment of the present invention, has been explained. In the following description, a method for generating a key pair and a method for reproducing DRM content are explained in detail with reference to FIGS. 3 and 4.

FIG. 3 is a flow chart that describes a method for generating a key pair, according to an embodiment of the present invention.

Referring to FIGS. 1 to 3, the portable terminal 100 is booted up (S301). The portable terminal 100 performs a registration process with respect to the mobile communication server 400 (S303). The mobile communication server 400 determines whether a loss notice of the SIM card 41 of the portable terminal 100 requested to be registered is recorded. If the mobile communication server 400 determines that a loss notice of the SIM card 41 is recorded, the mobile communication server 400 may reject the request to register the SIM card 41 (not shown). Since the registration process is well-known to the ordinary person skilled person in the art, its detailed description will be omitted in this application.

After that, the agent 113 of the portable terminal 100 checks whether the SIM card 41 is registered at the mobile communication server 400 (S305). If the agent 113 determines that the SIM card 41 is registered at the mobile communication server 400 at S305, the IMSI of the SIM card 41 is transmitted to the DRM core 111 (S307). An example of a registration is a case where a SIM card of a portable terminal that is not reported to be lost is installed to the portable terminal. The DRM core 111 receives the IMSI and creates a first key pair using the IMSI as a seed value (S309). After that, the DRM core 111 stores the first key pair (S311).

However, if the agent 113 ascertains that the SIM card 41 is not registered at the mobile communication server 400 due to a reported loss of the portable terminal 100 at S305, a random value instead of the IMSI of the SIM card 41 is transferred to the DRM core 111 (S313). The DRM core 111 receives the random value and creates a second key pair of the value as a seed value (S315). After that, the DRM core 111 stores the second key pair at S311. Alternatively, when the SIM card is not registered at the mobile communication server 400 due to a loss notice of the portable terminal, the first key pair is altered to the second key pair, so that other users cannot access the DRM contents stored in the portable terminal 100.

In an embodiment of the present invention, although a determination is made as to whether the SIM card 41 is registered while the portable terminal 100 is being booted up and then the first or second key pair is created, it should be understood that the present invention is not limited to the embodiment. For example, the portable terminal 100 may also perform the process of creating the key pair in an idle state. If the portable terminal 100 receives a message indicating that a loss notice has been recorded from the mobile communication server 400 the first key pair is altered to the second key pair stored therein.

In the foregoing description, the method for creating key pairs has been explained. A description is provided regarding a method for reproducing DRM content with reference to FIG. 4.

FIG. 4 is a flow chart that describes a method for reproducing DRM content, according to an embodiment of the present invention.

The portable terminal 100 detects a request to reproduce content (S401) and the DRM core 111 determines whether the requested content corresponds to DRM content (S403).

If the DRM core 111 ascertains that the requested content does not correspond to DRM content at 403, the DRM core 111 reproduces the requested content as general content (S411). This may include some decryption of the requested content or the content may be unencrypted and immediately available for reproduction.

However, if the DRM core 111 ascertains that the requested content corresponds to DRM content at 403, it checks whether a license corresponding to the DRM content exists, i.e., whether a license matching a key pair exists (S405). If a SIM card that has been reported lost is installed in the portable terminal 100, the portable terminal 100 creates a second key pair. In that case, although a license exists in the portable terminal 100, the DRM core 111 concludes that a legal license does not exist in the portable terminal 100.

However, if the DRM core 111 ascertains that a license does not exist at 405 (which is one of the cases where a SIM card reported lost is installed in a portable terminal, a SIM card of another user is installed to the portable terminal, and a SIM card of a user who does not purchase a license is installed in the portable terminal), the portable terminal displays a message asking whether a license is to be purchased on the display unit 130 (S407). If a user selects license purchase, the DRM core 111 requests to purchase a license from a DRM server 300 (not shown).

If the SIM card is normally registered at the mobile communication server 400 (i.e., if another user's SIM card is installed in the portable terminal or a user's SIM card is installed in the portable terminal), the DRM server 300 transmits a license to a portable terminal 100. That is, the DRM server 300 can transmit a license to a portable terminal only if the portable terminal user is a proper user. If a user installs their SIM card into another user's portable terminal and then purchases a license, the license purchase cost is charged not to the other user but to the user whose SIM card is installed. In addition, if a loss notice of a user's SIM card is reported, i.e., if a user's SIM card is used by an improper user, the DRM server 300 rejects a request to purchase a license.

However, if the DRM core 111 ascertains that a license exists at 405, the content reproducer 112 reproduces the requested DRM content (S409). To this end, the DRM core 111 decodes the DRM content, requested to be reproduced, using the stored license and then transfers it to the content reproducer 112.

As described above, the method and apparatus for protecting DRM content, according to the present invention, alters a key pair stored in the DRM core to a key pair of a random value as a seed value if a SIM card is not registered at a mobile communication server due to a report of a loss of the portable terminal, so that a person who picks up the portable terminal cannot access the DRM contents stored in the portable terminal.

In an embodiment of the present invention, although the first key pair is created by the IMSI as a seed value, it should be understood that the present invention is not limited to this specific embodiment. For example, according to the DRM design manner, the first key pair may be created by a preset first source as a seed value, without using the IMSI. In that case, the second key pair may be created by a second source as a seed value, which differs from the first source. In an embodiment of the present invention, although the first or second key pair is created by checking whether a SIM card is registered, it should be understood that the present invention is not limited to this specific embodiment. For example, it will be appreciated that the present invention can be applied to all types of portable terminals that have unique identification information so that their reported loss can be recorded in the mobile communication server 400, although the portable terminals do not have a SIM card. That is, the method and apparatus, according to the present invention, can check whether a loss notice of a portable terminal is recorded and create the first or second key pair.

As described above, the method and apparatus for protecting DRM content, according to the present invention, does not allow a person who picks up a portable terminal to access DRM content stored in the portable terminal, thereby protecting the rights of a user who lost the portable terminal. The present invention can be independently applied to portable terminals. That is, the present invention can be applied to various types of DRM technologies developed to protect DRM content stored in the portable terminals and does not increase the load of the DRM system.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer is loaded with, or accesses, code that may be stored in a memory component, the general purpose computer is transformed into a special purpose computer suitable for at least executing and implementing the processing shown herein.

Although the invention has been shown and described with respect to exemplary embodiments thereof, it should be understood that these embodiments are only illustrative and not intended to limit the scope of the invention. Therefore, one skilled in the art will understand that the embodiments disclosed in the description and configurations illustrated in the drawings are only preferred embodiments, instead there may be various modifications, alterations, and equivalents thereof, without departing from the scope and sprit of the invention as described in the accompanying claims.

What is claimed is:

1. An apparatus for preventing access to content protected by digital rights management (DRM) comprising:
an agent for checking whether an identification card is registered at a mobile communication server, the identification card having a unique identification value; and
a DRM core for creating a first key pair, using the unique identification stored on the identification card, and a second key pair using a random value, and storing the first or second key pair,
wherein the agent transfers the unique identification to the DRM core if the identification card is registered at the mobile communication server and the random value to the DRM core if the identification card is not registered at the mobile communication server.

2. The apparatus of claim 1, wherein, if a DRM content is requested to be reproduced, the DRM core checks whether a license corresponding to the DRM content exists using the first key pair or the second key pair, and decodes the DRM content if the license exists.

3. The apparatus of claim 2, further comprising:
a content reproducer for reproducing the decoded DRM content.

4. The apparatus of claim 2, further comprising:
a display unit for displaying a message asking whether to purchase a license if the license does not exist.

5. The apparatus of claim 4, further comprising:
a radio frequency (RE) communication unit for transmitting the message of purchasing a license to a rights issuing server if a user selects to purchase the license, and receiving the license from the rights issuing server.

6. The apparatus of claim 5, wherein the rights issuing server receives the message of purchasing a license, checks whether the user is a proper user, and transmits to a portable terminal a license to decode the DRM content if the user is a proper user, or rejects a request to purchase the license if the user is not a proper user.

7. The apparatus of claim 2, further comprising a storage unit for storing the license.

8. The apparatus of claim 1, wherein the identification card is selected from the group consisting of: a SIM card, a USIM card and a UIM card.

9. The apparatus of claim 1, wherein the unique identification is an IMSI.

10. A method, operable in a portable terminal, for limiting access to content protected by digital rights management (DRM), comprising:
checking whether an identification card is registered at a mobile communication server, the identification card including a unique identification value;
creating, if the identification card is registered at the mobile communication server, a first key pair using the unique identification value;
creating, if the identification card is not registered at the mobile communication server, a second key pair using a random value; and
storing the created one of the first key pair and the second key pair.

11. The method of claim 10, further comprising:
requesting reproduction of a DRM content;
checking whether a license corresponding to the DRM content exists; and
decoding and reproducing the DRM content if the license exists.

12. The method of claim 11, further comprising:
displaying a message asking whether to purchase a license if the license does not exist; and
transmitting the message of purchasing a license to a rights issuing server if a user selects to purchase the license.

13. The method of claim 12, further comprising:
checking whether a proper user requests to purchase a license, by the rights issuing server receiving the message of purchasing a license; and
transmitting to the portable terminal a license to decode the DRM content if the user is a proper user, or rejecting a request to purchase the license if the user is not a proper user.

14. The method of claim 10, wherein the identification card is selected from the group consisting of: a SIM card, a USIM card and a UIM card.

15. The method of claim 10, wherein the unique identification is an IMSI.

16. A portable terminal comprising:
a processor in communication with a memory, the memory including code which when accessed by processor causes the processor to:
determine whether an identification module associated with the portable terminal is registered at a remote site;
determine a key pair as one of: a unique identification obtained from the identification module when the identification module is determined to be registered and a random value when the identification module is determined not to be registered, and
access the DRM content when the selected key pair is valid and a license associated with the DRM content is available.

17. The terminal of claim 16, wherein the identification card is selected from the group consisting of: a SIM card, a USIM card and a UIM card.

18. The terminal of claim 16, wherein the unique identification is an IMSI.
